(19) United States
(12) Patent Application Publication
(10) Pub. No.: US 2026/0359586 A1
(43) Pub. Date: Nov. 12, 2026

(54) RFID Coupling Element and Associated Reading System for Singulated Reading of RFID-Tagged Medical Devices

(71) Applicant: Becton, Dickinson and Company, Franklin Lakes, NJ (US)

(72) Inventors: Cédric Rivier, Voreppe (FR); Emmanuel Viennois, Grenoble (FR); Julien Thuilliez, Meylan (FR)

(21) Appl. No.: 19/515,839

(22) PCT Filed: Sep. 18, 2024
(86) PCT No.: PCT/US2024/047217

§ 371 Date: Mar. 3, 2026

Related U.S. Application Data
(60) Provisional application No. 63/583,736, filed on Sep. 19, 2023.

(51) Int. Cl. G06K 7/10

(52) U.S. Cl. CPC G06K 7/10297

(57) ABSTRACT

Provided herein is a RFID reading system for performing a singulated reading of each of a plurality of RFID-tagged medical devices being conveyed by a conveyor system along a conveying path. The RFID reading system includes a RFID coupling element positioned at a reading location along the conveying path, the RFID coupling element comprising a housing, a housing mount, and a dipole coupling element positioned at least partially within the housing and including a pair of chamfered end portions. A RFID reader is operably connected with the RFID coupling element and is configured to provide power thereto to electromagnetically couple the dipole coupling element to the RFID tag of each RFID-tagged medical device as it passes in front of and in proximity to the dipole coupling element, at the reading location. The RFID reader then performs a singulated reading of the RFID tag in the RFID-tagged medical device.

### CROSS-REFERENCE TO RELATED APPLICATION

The present application claims priority to U.S. Provisional Application No. 63/583,736 entitled “RFID Coupling Element and Associated Reading System for Singulated Reading of RFID-Tagged Medical Devices” filed Sep. 19, 2023, the disclosure of which is hereby incorporated by reference in its entirety.

### BACKGROUND OF THE INVENTION

### Field of the Invention

The present disclosure relates generally to medical devices and, more particularly, to a RFID coupling element and associated RFID reading system for the singulated reading of RFID-tagged medical devices.

### Description of Related Art

In the areas of medical device design, manufacture, assembly, and usage, there is an increasing need for individual traceability of such devices from the manufacturing process until the final labeling, the final use, or the disposal of the medical devices. As an example, for injection devices such as syringes or auto-injectors, traceability and connectivity of the injection devices, as well as data recording and retrieving, is becoming the norm.

Some prior attempts to address this need for traceability during manufacturing and/or along the supply chain have implemented RFID tags (including a RFID chip and a RFID antenna) on the medical devices for remote identification thereof. However, in integrating an RFID tag into medical devices, it is necessary to perform quality control processing of RFID-tagged products during manufacturing-including ensuring operability of the RFID tag and/or ensuring proper alignment/positioning of the RFID tag in/on the medical device.

Existing solutions for performing quality control processing of RFID-tagged products during manufacturing suffer from deficiencies that may impact the ability to provide reliable manufacturing standards for the RFID-tagged products. For example, most “off the shelf” RFID readers and antenna solutions provide for the mass reading of inventory (i.e., the reading of several RFID-tagged items at the same time), but such mass reading is not suitable when it is desired to perform a singulated reading of each of a plurality of RFID-tagged products, such as may be desired for quality control processing of the RFID-tagged products during manufacturing. While near-field antennas coupled to RFID readers are available for the singulated reading of RFID-tagged products, the characteristics of these RFID near filed antennas (due to their beam pattern, coupling type, etc.) may not not compatible with the manufacturing requirements of medical devices such as RFID-tagged injection devices including requirements regarding pitch (e.g., 60 mm, 30 mm, or less) and conveyance speed (e.g., >1 m/s) of the RFID-tagged injection devices as they are processed along a conveyor system or system. Accordingly, attempts to read RFID-tagged injection devices in a singulated fashion during manufacturing using existing RFID reading systems typically results in a cross-reading defect-with a cross-reading defect referring to when the RFID-tagged injection devices are not read in the correct conveying run order (i.e., a 2^{nd} position device is read before a 1^{st} position device).

Accordingly, a need exists in the art for a system and method that addresses the above-mentioned drawbacks by providing an effective and dependable means for performing a singulated reading of RFID-tagged medical devices during the manufacturing thereof, with the system and method able to provide an accurate singulated reading of such devices in accordance with the required pitch and conveyance speed associated with the manufacturing environment.

### SUMMARY OF THE INVENTION

Provided herein is a RFID reading system for performing a singulated reading of each of a plurality of RFID-tagged medical devices being conveyed by a conveyor system along a conveying path. The RFID reading system includes a RFID coupling element positioned at a reading location along the conveying path, with the RFID coupling element comprising a housing comprising a front surface, a back surface, and a plurality of mounting features, a dipole coupling element positioned at least partially within the housing and including a pair of chamfered end portions, and a housing mount to which the housing is secured, with at least some of the plurality of mounting features aligned with the housing mount to enable securing of the housing to the housing mount. The RFID reading system also includes a RFID reader operably connected with the RFID coupling element, the RFID reader configured to provide power to the RFID coupling element to electromagnetically couple the dipole coupling element to an RFID tag incorporated in a respective RFID-tagged medical device as it passes in front of and in proximity to the dipole coupling element, at the reading location. Upon the electromagnetic coupling of the dipole coupling element to the respective RFID-tagged medical device, the RFID reader performs a singulated reading of the RFID tag in the RFID-tagged medical device.

In certain configurations, the end portions of the dipole coupling element have a width, in an x-dimension, sufficient to acquire a reading of the RFID-tagged medical device as it passes the reading location.

In certain configurations, the end portions of the dipole coupling element are separated in a y-dimension.

In certain configurations, the end portions of the dipole coupling element are separated in the y-dimension by a distance determined by a configuration of the RFID tags of the RFID-tagged medical devices.

In certain configurations, the end portions of the dipole coupling element are separated in the y-dimension by a distance determined by a configuration of carrier tools of the conveyor system that hold the RFID-tagged medical devices.

In certain configurations, a polarization axis or dipole axis of the dipole coupling element is substantially parallel to a polarization axis or dipole axis of the RFID tag included in each respective RFID-tagged medical device.

In certain configurations, the polarization axis or dipole axis of the dipole coupling element is within +/−30 degrees of parallel to the polarization axis or dipole axis of the RFID tag.

In certain configurations, the plurality of mounting features and the housing mount enable 3-dimensional positional adjustment of the housing and the dipole coupling element. The positional adjustments include a positional adjustment in an x-dimension parallel to a direction of travel of the conveying path at the reading location, a positional adjustment in a z-dimension, away from and towards a respective RFID-tagged medical device when at the reading location, and a positional adjustment in a y-dimension, vertically up and down relative to a respective RFID-tagged medical device when at the reading location, so as to enable vertical centering of the dipole coupling element relative to a RFID tag in a respective RFID-tagged medical device.

In certain configurations, positional adjustments of the housing and the dipole coupling element in the z-dimension enable adjustment of up to 50 mm, in increments of 0.1 mm or less.

In certain configurations, positional adjustments of the housing and the dipole coupling element in the y-dimension enable adjustment of up to 2 mm, in increments of 0.1 mm or less.

In certain configurations, the housing is formed of one or more cleanroom-compatible materials.

In certain configurations, at least a portion of the front surface of the housing adjacent or in close proximity to the end portions of the dipole coupling element is formed of non-metallic material compatible with radio-frequency constraint and performance.

In certain configurations, the RFID reading system further includes a radio frequency (RF) cable connecting the RFID reader to the RFID coupling element, the RF cable enabling positioning of the RFID coupling element at the reading location, along the conveying path.

In certain configurations, the plurality of RFID-tagged medical devices comprise assembled RFID-tagged syringes, RFID-tagged syringe tip caps, RFID-tagged auto-injectors, or RFID-tagged safety devices.

Also provided herein is a RFID coupling element for use with a RFID reader for performing a singulated reading of each of a plurality of RFID-tagged medical devices being conveyed by a conveyor system along a conveying path. The RFID coupling element includes a housing comprising a front surface and a back surface and a plurality of mounting features, a housing mount to which the housing is secured, with at least some of the plurality of mounting features aligned with the housing mount to enable securing of the housing to the housing mount, and a dipole coupling element positioned at least partially within the housing, the dipole coupling element having a pair of chamfered end portions. Upon power being provided to the dipole coupling element, the dipole coupling element is electromagnetically coupled to a RFID tag incorporated in a respective RFID-tagged medical device as it is conveyed along the conveying path to a reading location, where it passes in front of and in proximity to the dipole coupling element, so as to enable a singulated reading of the RFID-tagged medical device.

In certain configurations, the end portions of the dipole coupling element have a width, in an x-dimension, sufficient to acquire a reading of the RFID-tagged medical device as it passes the reading location.

In certain configurations, the end portions of the dipole coupling element are separated in a y-dimension by a distance determined by a configuration of the RFID tags of the RFID-tagged medical devices and/or by a configuration of carrier tools of the conveyor system that hold the RFID-tagged medical devices.

### BRIEF DESCRIPTION OF THE DRAWINGS

FIG. 1 is a perspective view of a RFID-tagged syringe, with which embodiments of the disclosure may be implemented;

FIG. 2 is an exploded view of the syringe of FIG. 1;

FIG. 3 is a side view of a tip cap included in the syringe of FIG. 1, illustrating orientation of an RFID tag incorporated into the tip cap, according to a non-limiting embodiment described herein;

FIG. 4 illustrates a manufacturing environment in which a method of manufacturing and reading of a plurality of syringes, such as the syringe of FIG. 1, may be performed, according to a non-limiting embodiment described herein;

FIG. 5 is a block schematic diagram of a conveyor system and RFID reading system included in the manufacturing environment of FIG. 4, according to a non-limiting embodiment described herein;

FIG. 6 is a perspective view of a RFID coupling element used in the RFID reading system of FIG. 5, according to a non-limiting embodiment described herein;

FIG. 7 is a detailed perspective view of a housing of the RFID coupling element of FIG. 6;

FIG. 8A is a front view of the housing of the RFID coupling element of FIG. 6;

FIG. 8B is a front view of the housing of the RFID coupling element of FIG. 6;

FIG. 8C is a side view of the housing of the RFID coupling element of FIG. 6;

FIG. 8D is a rear view of the housing of the RFID coupling element of FIG. 6;

FIG. 9 is a front perspective view of the RFID coupling element of FIG. 6 positioned relative to RFID-tagged syringes being conveyed along a conveyor system, according to a non-limiting embodiment described herein; and

FIG. 10 is a side perspective view of the RFID coupling element of FIG. 6 positioned relative to RFID-tagged syringes being conveyed along a conveyor system, according to a non-limiting embodiment described herein;

FIG. 11 is a side perspective view of the RFID coupling element of FIG. 6 positioned relative to an RFID-tagged tip cap held by a carrier tool for being conveyed along a conveyor system, according to another non-limiting embodiment described herein;

FIG. 12 is a block schematic diagram illustrating the performing of singulated readings of RFID-tagged syringes by the RFID reading system of FIG. 5, according to a non-limiting embodiment described herein; and

FIG. 13 is a block schematic diagram illustrating alignment of the RFID coupling element and the RFID tag incorporated in an RFID-tagged syringe, according to a non-limiting embodiment described herein.

### DESCRIPTION OF THE INVENTION

The following description is provided to enable those skilled in the art to make and use the described embodiments for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

In the present disclosure, the distal end of a component or of a device means the end furthest away from the hand of the user and the proximal end means the end closest to the hand of the user, when the component or device is in the use position, i.e., when the user is holding a syringe in preparation for or during use. Similarly, in this application, the terms “in the distal direction” and “distally” mean in the direction toward the distal tip of the syringe, and the terms “in the proximal direction” and “proximally” mean in the direction opposite the direction of the distal tip of the syringe.

Aspects and embodiments of the disclosure are directed to a system and method for the singulated reading of RFID-tagged medical devices during manufacturing thereof for purposes of quality control.

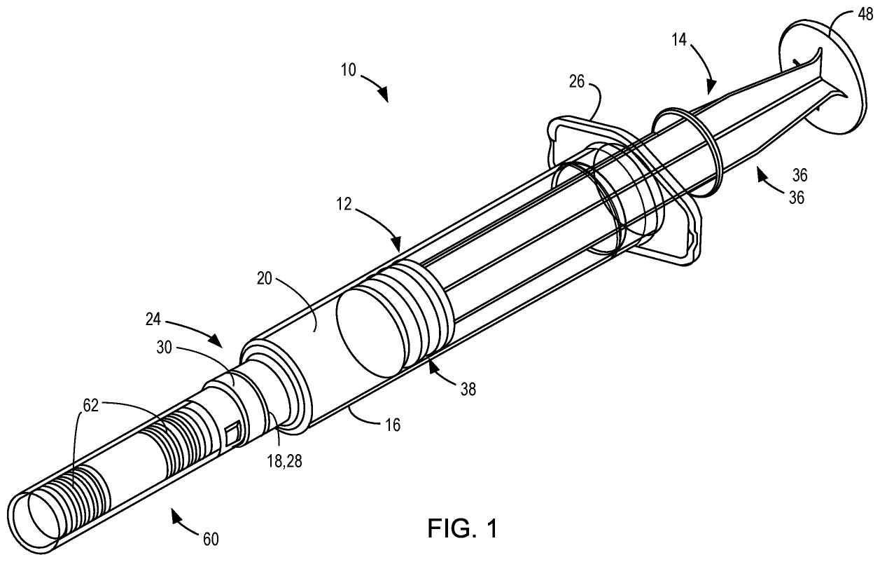

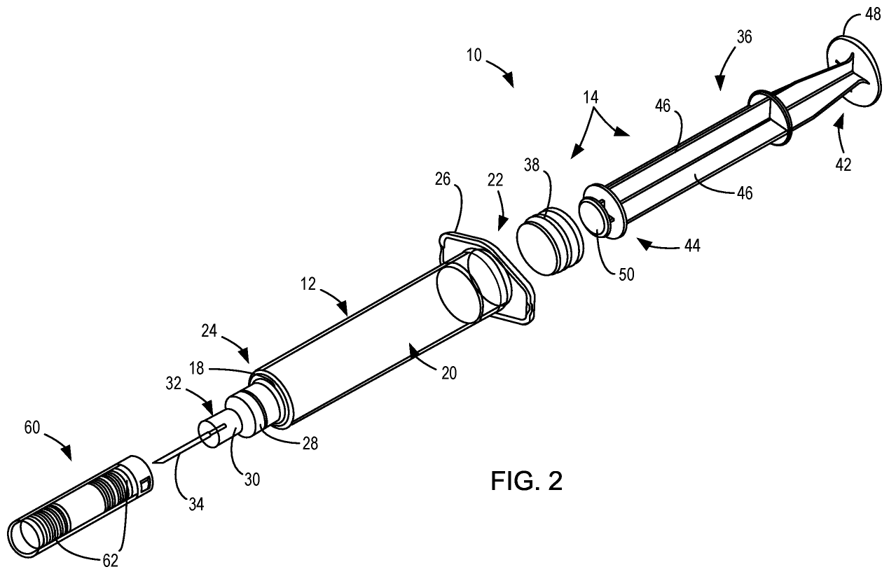

Referring to FIGS. 1 and 2, shown is a non-limiting embodiment of a RFID-tagged medical device with which aspects or embodiments of the disclosure may be implemented. While the medical device is shown and described hereafter as a syringe (“syringe 10”), it is recognized that other RFID-tagged medical devices, including other medical injection devices (e.g., auto-injectors) or safety devices may be utilized with the system and method of the disclosure described in detail here below.

As shown in FIGS. 1 and 2, the syringe 10 generally includes a syringe barrel 12 and a plunger assembly 14. The plunger assembly 14 is movable within the syringe barrel 12 along a longitudinal axis to an advanced position to facilitate administering of an injectable fluid (e.g., medication) to a patient, for example. The syringe barrel 12 is formed of a generally cylindrical outer wall 16 and an end member 18 that collectively define a chamber 20 for retaining fluid therein. The syringe barrel 12 includes an open proximal end 22 configured to receive the plunger assembly 14 therein and a distal end 24 at which end member 18 is positioned. The proximal end 22 of the syringe barrel 12 may include a flange 26 to facilitate handling and positioning of the syringe 10 and to maintain the relative position of the syringe barrel 12 with respect to the plunger assembly 14 during medication administration. At the distal end 24, the end member 18 may include a shoulder 28 which narrows with respect to the cylindrical outer wall 16, as well as a hub portion 30 extending out distally from shoulder 28. The hub portion 30 is formed as a partially hollow member that defines a channel 32 therethrough in fluid communication with the chamber 20. In some embodiments, a needle 34 is attached to the hub portion 30 within channel 32, such as by being glued or otherwise secured to the hub portion 30. In other embodiments, it is recognized that-rather than needle 34 syringe 10 could instead include a luer connection formed at the distal end 24 of syringe barrel 12 that enables the syringe 10 to be directly coupled to a luer connection of an associated medical device or component, to provide for the direct transfer of fluids therebetween.

The plunger assembly 14 of syringe 10 is formed of an elongate plunger rod 36 (more generally “plunger 36,” as used hereafter) and a plunger head or stopper 38. The plunger 36 may include a main body 40 extending between a plunger proximal end 42 and a plunger distal end 44. In some embodiments, the main body 40 may include a plurality of elongate vanes or walls 46 extending axially along a length thereof between the plunger proximal end 42 and the plunger distal end 44. A thumb press 48 is positioned at the plunger proximal end 42 that may be engaged by a thumb (or other finger) of the user to apply a distally directed force to the plunger assembly 14 to move the plunger 36 with respect to the syringe barrel 12. In some embodiments, a flanged extension member 50 (e.g., disc-shaped flange) is positioned at the plunger distal end 44 that is configured to mate with the stopper 38. In other embodiments, the plunger distal end 44 may include a female receptacle formed therein that is configured to receive and connect to a protrusion (e.g., pin) extending out proximally from the stopper, with the protrusion and receptacle engaging via threading, for example.

The stopper 38 of plunger assembly 14 is positioned at the plunger distal end 44 so as to be movable along with the plunger 36 within the chamber 20 of syringe barrel 12. The stopper 38 may be made from a material that is different from the material of the plunger 36 and that is capable of forming a tight seal with the syringe barrel 12 as it is advanced therethrough. In some embodiments, the stopper 38 includes a receptacle (not shown) formed therein that is sized and configured to receive the flanged extension member 50 of plunger 36, with the flanged extension member 50 coupling with the receptacle via a press fit connection, for example, to secure the stopper 38 to the plunger 36, although it can be appreciated that the stopper 38 and plunger distal end 44 can be secured by other techniques known in the art.

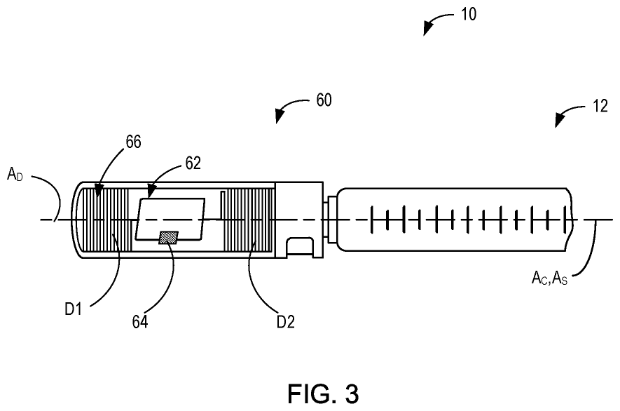

As shown in FIGS. 1 and 2, and now also in FIG. 3, syringe 10 further includes a tip cap 60 that may be coupled to the hub portion 30 of syringe barrel 12. While shown in FIGS. 1 and 2 as a needle shield that is used to protect the needle 34, tip cap 60 could instead be configured as a cap that covers a luer connection. According to aspects and embodiments of the disclosure, the tip cap 60 may include an RFID tag 62 integrated therein that allows for identification and/or tracking of the syringe 10. That is, the RFID tag 62 may include or store information thereon regarding the contents of the syringe 10 (i.e., the medication or drug included therein, if a prefilled syringe) and the manufacturing history of the syringe and/or may provide location information to an associated reader, so as to enable tracking of the syringe 10. Accordingly, the RFID tag 62 is considered to generally include thereon a unique identifier (UID) that is specific to the syringe 10. According to aspects or embodiments of the disclosure, the RFID tag 62 may be integrated into the tip cap 60, such as by being inlaid or otherwise disposed between an inner casing and outer casing of the tip cap. According to other embodiments, the RFID tag 62 may be applied to an outer surface of the tip cap 60. According to still other embodiments, it is recognized that rather than being integrated into/on the tip cap 60, the RFID tag 62 could instead be applied onto another component of the syringe 10, such as onto the syringe barrel 12 (i.e., onto the cylindrical outer wall 16 or flange 26 thereof) or onto the plunger rod 36. In each of these embodiments, the RFID tag 62 conforms to the surface(s) or wall(s) to or within which it is disposed, such that when the RFID tag 62 is integrated with/on a cylindrical component such as the tip cap 60 or barrel 12, the RFID tag 62 will have a curvature that matches that of the tip cap 60 or barrel 12.

According to embodiments, and as shown in FIG. 3, the RFID tag 62 includes an RFID chip 64 connected to an RFID dipole coupling element 66. The RFID dipole coupling element 66 of RFID tag 62 may include two legs or dipoles D1, D2, with the RFID chip 78 disposed between extremities of the dipoles D1, D2, such as being centered therebetween. In some embodiments, the RFID tag 62 may be positioned and oriented within tip cap 60 such that a dipole axis, A_{D}, of the RFID tag 62 is approximately aligned with a longitudinal axis, A_{C}, of the tip cap 60 (and a longitudinal axis, As, of the syringe 10), such that more strict quality controls may be implemented during manufacturing/assembly of the syringe 10 and the cap 60 thereof, as explained in further detail below. In other embodiments, the RFID tag 62 may be positioned and oriented within tip cap 60 such that the dipole axis, Ap, of the RFID tag 62 is oriented at a specified angle relative to the longitudinal axis, A_{C}, of the tip cap 60, such as within +/−20 degrees of the longitudinal axis A_{C} of the tip cap 60, as a non-limiting example.

According to aspects of the disclosure, a system and method for testing or interrogation of RFID-tagged medical devices (hereafter “reading” of a device) is provided. In some embodiments, the RFID-tagged medical devices may be provided as syringes 10 as shown and described in FIGS. 1-3, but it is recognized that the devices could instead be other medical injection devices (e.g., auto-injectors) or other medical devices (e.g., safety devices) having a RFID tag integrated thereon/therein.

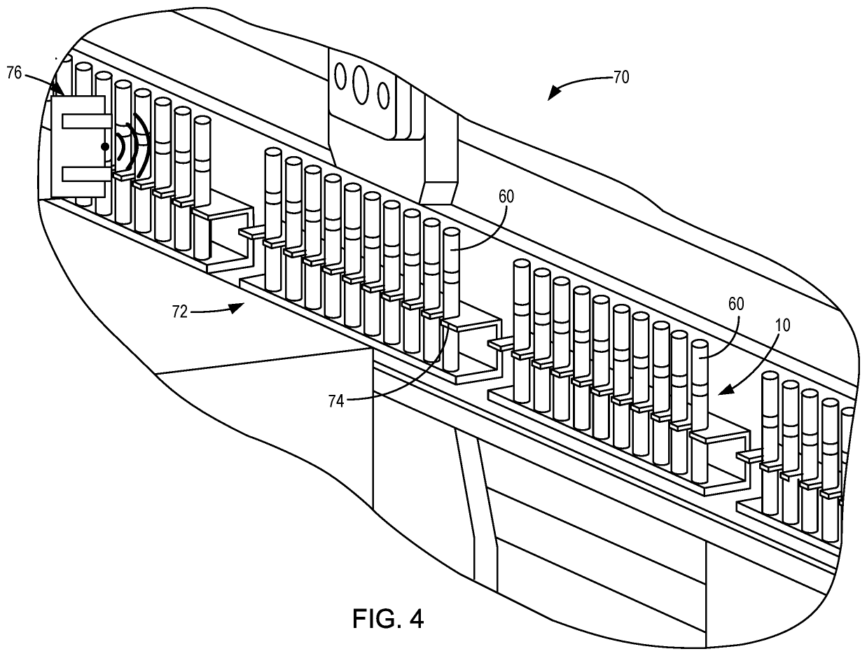

Referring now to FIG. 4, a manufacturing and reading environment within which RFID-tagged medical devices 10 (hereafter “RFID-tagged syringes 10”) may be read is illustrated in accordance with an aspect of the disclosure. According to some aspects of the disclosure, reading of the RFID-tagged syringes 10 may be implemented as part of a quality control process for the syringes. However, it is recognized that reading of the RFID-tagged syringes 10 may be implemented for other processes associated with manufacturing and/or subsequent tracking of the syringes.

As shown in FIG. 4, a system 70 is provided that includes a conveyer system 72 on and along which a plurality of RFID-tagged syringes 10 may be dynamically conveyed/translated as part of an assembly and quality control process. The RFID-tagged syringes 10 may be conveyed by conveyer system 72 along a path that is linear or circular, according to various embodiments. Each of the RFID-tagged syringes 10 may be retained by a holding or gripping device or carrier tool 74 of the conveyor system 72, with the RFID-tagged syringes 10 held in position by mechanical force, suction, or another suitable means. As the RFID-tagged syringes 10 progress along the conveyor system 72, they pass by a RFID reading system 76 of system 70, a portion of which is shown in FIG. 4. As explained in further detail below, the RFID reading system 76 is configured to read or interrogate the RFID tag 62 in each of the RFID-tagged syringes 10 in a singulated manner, so as to determine proper operability of each tag as part of a quality control process. According to embodiments of the disclosure, the conveyor system 72 may be operated/constructed as a “high throughput” conveyer line that conveys the RFID-tagged syringes 10 along the conveyor path at a high rate and with a tight pitch between the RFID-tagged syringes 10, to enable a reading rate for the RFID-tagged syringes 10. As a non-limiting example, the RFID reading system 76 and conveyor system 72 may function cooperatively to enable a read rate of 100 parts/sec or 6000 parts/min, with such a read rate achievable with the conveyor system 72 advancing the RFID-tagged syringes 10 at a speed of approximately 1 m/s and at a pitch of approximately 19 mm.

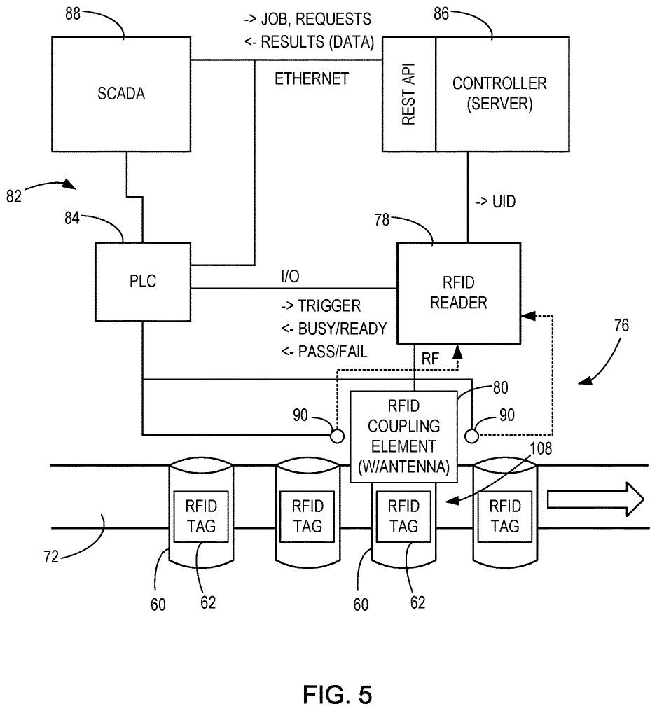

The components of RFID reading system 76 are shown in more detail in the schematic diagram of FIG. 5, according an embodiment of the disclosure. The RFID reading system 76 may include an RFID reader 78 and accompanying RFID coupling element 80 (with dipole coupling element 96) that are able to read the RFID tag 62 of each RFID-tagged syringe 10 conveyed along conveyor system 72. A control system 82 may also be provided (as part of, or separately but in operational association) with the RFID reading system 76, by which operation of the RFID reader 78 (and, optionally, operations of the conveyor system 72) may be selectively controlled and/or by which readings obtained by the RFID reader 78 may be processed and analyzed. In the illustrated non-limiting embodiment, control system 82 includes a programmable logic controller (PLC) 84, a server/database and associated application programming interface (API) 86, an (optional) supervisory control and data acquisition (SCADA) system 88, and a sensor/sensing system 90, with these control system components collectively providing for operation of the conveyor system 72, along with controlling aspects of the RFID reading system 76 to enable reading of the RFID tags of syringes 10 and retrieval of the UIDs therefrom, such as may be desirable for quality control and/or other manufacturing-related controls or parameters.

The RFID reader 78 may be of a known architecture that provides for the reading of RFID tags 62 in the syringes 10 to retrieve the UIDs thereof. Thus, while not shown in FIG. 5, it is understood that the RFID reader 78 may include, as a non-limiting example, some/all of the following circuits, modules, or control means: a clock means for delivering a clock signal for clocking the modulation and demodulation operations of transmitted and received electromagnetic signals, a modulation circuit for generating adequate modulation of the electromagnetic field, an amplification and control circuit for driving RFID coupling element 80, a demodulation circuit for demodulating the modulated responses transmitted by the RFID tags 62 and picked up by RFID coupling element 80, an amplification and filtering circuit for the signals produced at the output of demodulation circuit, and/or a decoding circuit for the demodulated, amplified and filtered signals.

Command signals for controlling operation of the RFID reader 78 may be provided by PLC 84, with the PLC 84 and RFID reader 78 in operable communication with each other. In some embodiments, the PLC 84 and RFID reader 78 may be in direct communication with each other, such as along an input/out cable or communication line. In other embodiments, the PLC 84 and RFID reader 78 may be in indirect communication with each other through a communications network, such as through a computer that controls operation of the PLC 84 via a network connection (e.g., RFID reader may transmit signals to a computer in charge of communication with the controller).

According to aspects of the disclosure, the PLC 84 may provide trigger signals to the RFID reader 78 to control operation thereof regarding the reading of the RFID tags 62 integrated in the RFID-tagged syringes 10. According to embodiments, transmitting of the trigger signals to the RFID reader 78 may be may be determined based on positioning of the RFID-tagged syringes 10 relative to the RFID coupling element 80, although it is recognized that in other embodiments, a continuous reading scheme could be employed by which the RFID reader 78 is to be operated. As one example, the PLC 84 may determine when to transmit trigger signals to the RFID reader 78 based on signals received by the PLC 84 from the one or more sensors 90 that identify/detect positioning of the RFID-tagged syringes 10 on the conveyor system 72 relative to the RFID coupling element 80, with such positional information determining appropriate times for triggering the RFID reader 78 and RFID coupling element 80 to enable a singulated reading of each RFID-tagged syringe 10. In other embodiments, the sensor(s) 90 may be directly connected to RFID reader 78, with the sensor(s) 90 transmitting trigger signals directly to the RFID reader 78 to trigger the RFID reader 78 and RFID coupling element 80 to enable a singulated reading of each RFID-tagged syringe 10—thus eliminating the PLC 84 from the triggering process.

According to aspects of the disclosure, the PLC 84 may be in two-way communication with RFID reader 78 via the input/out cable or communication line, with the PLC 84 receiving output signals from RFID reader 78. As explained in further detail below, the PLC 84 may receive output signals from the RFID reader 78 regarding g whether the reading of an RFID-tagged syringe 10 was performed successfully (i.e., a “Pass/Fail” signal).

Additionally, according to aspects of the disclosure, the PLC 84 may be in operable communication with the conveyor system 72. In some embodiments operation of the conveyor system 72 may be controlled by PLC 84, including controlling of the conveyor speed and starting/stopping of the conveyor system 72. The PLC 84 may also control operation of the conveyor system 72 in connection with performing a quality control of the RFID-tagged syringes 10. That is, as explained in further detail below, the PLC 84 may control conveyor system 72 (i.e., gripping devices 74) to provide for the selective ejection of defective RFID-tagged syringes 10 therefrom, as may be determined by the singulated reading of each of the RFID-tagged syringes 10 by the RFID reading system 76.

As indicated above, control system 82 may optionally include a server/database 86 in operable communication with the RFID reader 78 to receive outputs therefrom. In accordance with aspects of the disclosure, the server/database 86 may receive reading data from the RFID reader 78 resulting from the reading of RFID-tagged syringes 10—i.e., UIDs of the RFID-tagged syringes 10. The server/database 86 may include memory modules therein that store the UID data for RFID-tagged syringes 10.

According to aspects of the disclosure, the RFID coupling element 80 included in RFID reading system 76 is specifically configured to provide for the singulated reading of the RFID-tagged syringes 10, for retrieving UIDs therefrom, as the RFID-tagged syringes 10 are moved along the conveyor system 72 during the manufacturing thereof. As indicated above, the conveyor system 72 may be operated as a high throughput conveyer line that conveys the RFID-tagged syringes 10 along the conveyor path at a speed and a pitch that provides for singulated readings of the RFID-tagged syringes 10 at up to 6,000 parts/min, with the RFID coupling element 80 constructed accordingly to enable such singulated readings of the RFID-tagged syringes 10 as they are moved along the conveyor system 72, while also minimizing/eliminating the potential for cross-reading defects during reading of the RFID-tagged syringes 10.

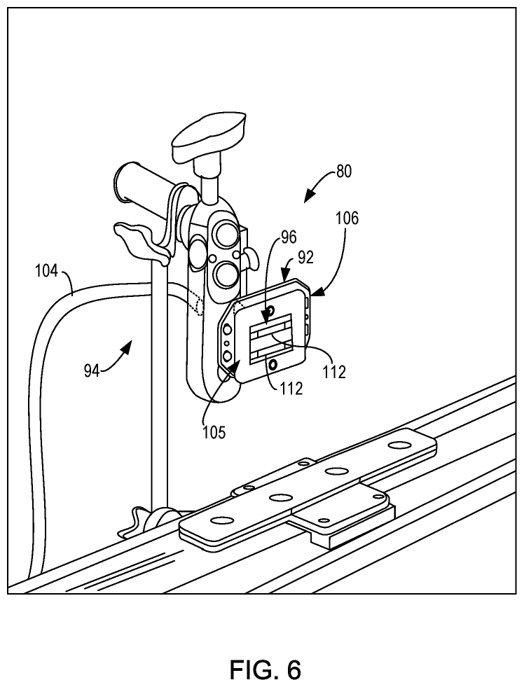

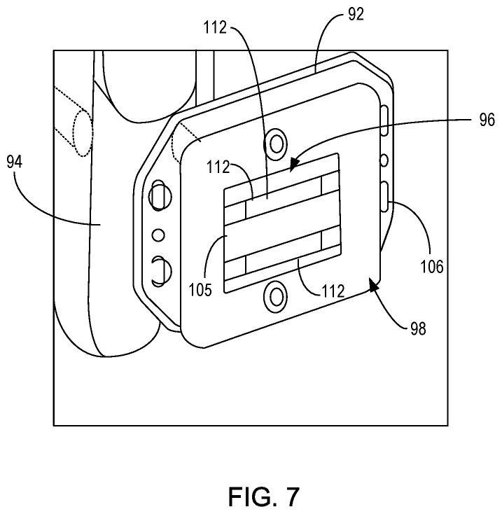

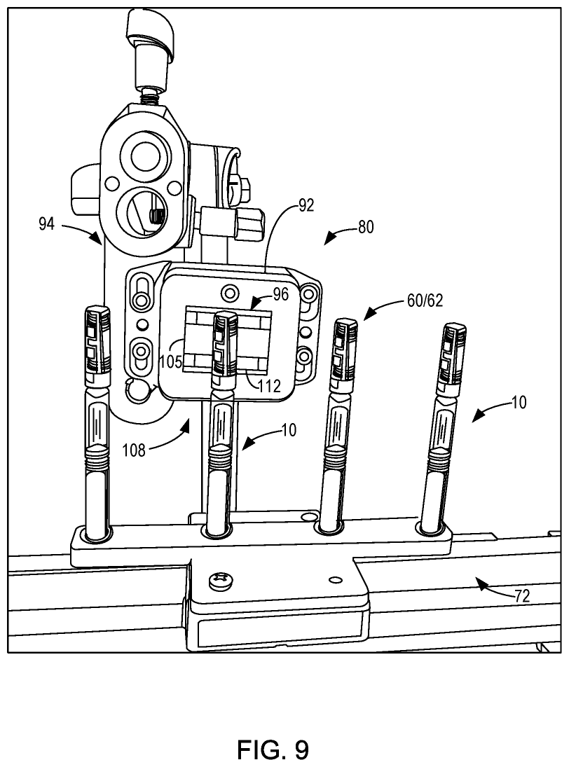

Referring now to FIGS. 6-11, and with continued reference to FIGS. 1-5, the RFID coupling element 80 is shown as generally including a housing 92, a mount 94, and a dipole coupling element 96. The housing 92 may be a generally rectangular-shaped structure that defines an inner volume, with the housing 92 having a front surface 98 and a back surface 100. The housing 92 may be sized so as to enable positioning of the RFID coupling element 80 in close proximity to the conveyor system 72 and to the RFID-tagged syringes 10 being conveyed therealong. In some embodiments, the housing 92 may have dimensions of 77 mm wide×50 mm tall×21 mm deep, to provide for positioning of the RFID coupling element 80 in a tight/restrained space near the conveyor system 72. A co-axial connector 102 may be provided on the back surface 100 of the housing 92, to which an RF cable 104 may be connected that operatively connects the RFID reader 78 to the RFID coupling element 80. In some embodiments, the RF cable 104 may have a length sufficient to provide for positioning of the RFID coupling element 80 near the conveyor system 72, while the RFID reader 78 is positioned at a more remote location where space constraints are not an issue. Thus, in some embodiments, the RF cable 104 may have a length of 1.5 meters to 2 meters, as a non-limiting example.

According to aspects of the disclosure, the housing 92 may be formed from cleanroom-compatible materials, as may be required for manufacturing of the RFID-tagged syringes 10. Thus, housing 92 may be formed from stainless steel, polyether-ether-ketone (PEEK), or aluminum, as non-limiting examples. Furthermore, at least portions of the housing 92 may be formed of a non-metallic material that does not impact RF characteristics of the RFID coupling element 80—i.e., of RF signal transmission/receipt by the dipole coupling element 96 during reading of the RFID tags 62. For example, at least a portion of the front surface 98 of the housing 92—indicated at 105—adjacent to or in close proximity to the dipole coupling element 96 is formed of a non-metallic material, such as a suitable polymeric material. The size of the housing portion 105 formed of such material may vary based on the configuration of end portions of the dipole coupling element 96, but as a non-limiting example, the housing portion 105 may be a square portion of 20 mm×20 mm. In other embodiments, the entire front surface 98 may be provided as a cover formed of a non-metallic material that does not impact RF characteristics of the RFID coupling element 80.

According to some aspects of the disclosure, a plurality of mounting features 106 may be provided on the housing 92, such as on each of opposing ends of the housing 92, with the mounting features 106 providing for securing and/or adjustment of the housing 92 on the mount 94. According to some embodiments, the mounting features 106 may comprise an arrangement of openings or holes that may be aligned with corresponding openings or holes on the mount 94, such that fasteners may be inserted therein to secure the housing 92 to the mount 94.

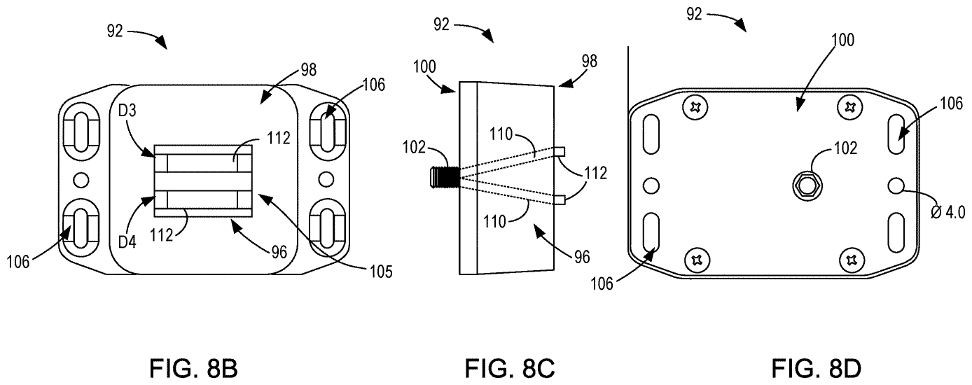

According to some aspects of the disclosure, the mount 94 and/or engagement between the mount 94 and the housing 92 (via mounting features 106) may provide for 3-dimensional positional adjustment of the RFID coupling element 80. That is, a positional adjustment of the RFID coupling element 80 may be enabled in: an x-dimension parallel to a direction of travel of the conveying path of the RFID-tagged syringes 10 (at a reading location 108 where the RFID-tagged syringes 10 are read by the RFID reading system 76); a z-dimension, away from and towards a respective RFID-tagged syringe 10 when at the reading location 108; and a y-dimension, vertically up and down relative to a respective RFID-tagged syringe 10 when at the reading location 108, so as to enable vertical centering of the RFID coupling element 80 relative to the RFID tag 62 in a respective RFID-tagged syringe 10, as best shown in FIGS. 9-13. According to embodiments of the disclosure, the 3-dimensional positional adjustment of the RFID coupling element 80 may be provided for via manual adjustments to the mount 94 and/or between the mount 94 and the housing 92, such as via an adjustment of fasteners or via electronically controlled adjustments to the mount 94 and/or between the mount 94 and the housing 92, such as via servo-motors provided on the mount 94. As non-limiting examples, a positional adjustment of from 1-50 mm (in increments of 0.1 mm) may be provided in the z-dimension and a positional adjustment of 2 mm (in increments of 0.1 mm or finer) may be provided in the y-dimension.

According to some embodiments of the disclosure, the 3-dimensional positional adjustment of the RFID coupling element 80 may be provided for via manual adjustments to the mount 94 and/or between the mount 94 and the housing 92. As one example, the openings or holes forming the mounting features 106 on housing 92 may be re-aligned with corresponding openings or holes on the mount 94, with fasteners then subsequently securing the housing 92 and mount 94, to adjust positioning of the housing 92 (and dipole coupling element 96 therein) in at least one dimension. As another example, an actuator or adjustment feature on the mount 94 (e.g., swivel, telescoping rod, etc.) may be manually actuated by an operator, to adjust positioning of the housing 92 (and dipole coupling element 96 therein) in at least one dimension. According to other embodiments of the disclosure, the 3-dimensional positional adjustment of the RFID coupling element 80 may be provided for via electronically controlled adjustments to the mount 94 and/or between the mount 94 and the housing 92. As one example, servo-motors on the mount 94 may be selectively operated to adjust positioning of the housing 92 (and dipole coupling element 96 therein) in at least one dimension.

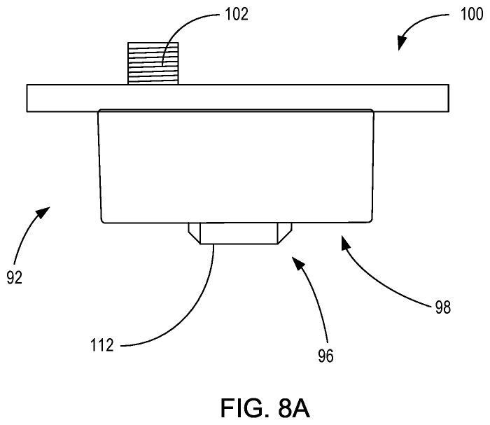

As shown best in FIGS. 8A-8D, the dipole coupling element 96 of RFID coupling element 80 is at least partially contained within the housing 92 and may be formed of a pair of thin wires 110 (e.g., 1.6 mm in diameter). The dipole coupling element 96 includes end portions 112 that provide a first dipole element D3 and a second dipole element D4 of the dipole coupling element 96. In some embodiments, each of the end portions 112 may be arranged in parallel with the front surface 98 of the housing 92, and may extend slightly out from the front surface 98 of the housing 92 (in the z-dimension) through corresponding slots formed in the front surface 98 of the housing 92, so as to be exposed from housing 92.

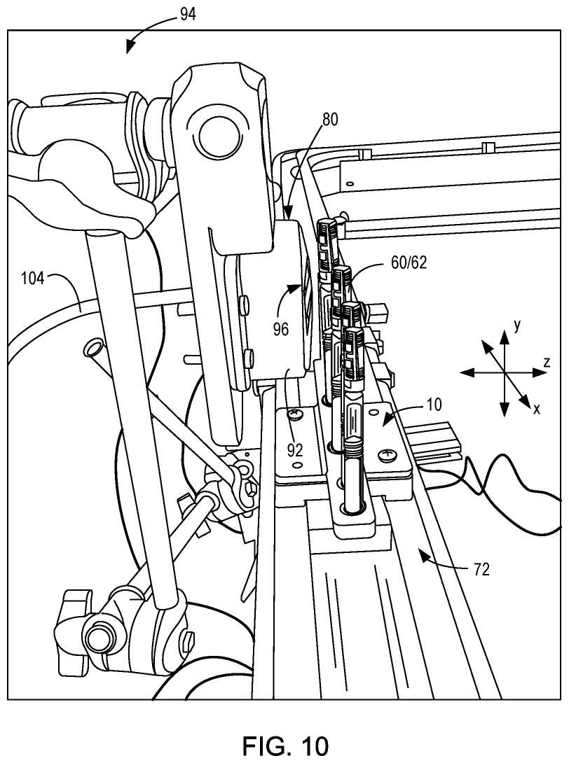

As shown in FIG. 11, in accordance with one aspect of the disclosure, the extension of the end portions 112 out from front surface 98 may allow for the dipole coupling element 96 to be placed in between grooves 114 of a carrier tool 74 of conveyor system 72 used for manufacturing of the tip cap 60—in order to ensure close proximity with the RFID tag 62 without any contact with the carrier tool 74. The extension of the end portions 112 out from front surface 98 also enables reading of the RFID tag 62 assembled into the tip cap 60 with a carrier tool 74 made from steel or stainless steel.

Referring again to FIGS. 8A-8D, in some embodiments, the end portions 112 of the dipole coupling element 96 are constructed as chamfered end portions that present a smooth outwardly-facing surface on dipole coupling element 96. The chamfered end portions 112 may thus prevent particle generation during the RFID reading process, in case of a RFID-tagged syringe (i.e., of tip cap 60 thereof) coming into contact with the end portions 112 as they are moved along the conveyor system 72 and through reading location 108.

According to aspects of the disclosure, and as best shown in FIGS. 9-11, the dipole coupling element 96 of RFID coupling element 80 is configured such that the end portions 112 thereof are aligned with the dipole elements (D1, D2 in FIG. 3) of the RFID tag 62 integrated in the RFID-tagged syringe 10. The alignment of the end portions 112 of dipole coupling element 96 may be both spatially (in the y-dimension) and angularly. According to one aspect of the disclosure, and as shown in FIG. 11, the end portions 112 of dipole coupling element 96 may be spaced apart (in the y-dimension) so as to best align with dipoles of the RFID tag 62 in the RFID-tagged syringe 10, while also aligning in between grooves 114 of the carrier tool 74 of conveyor system 72 that is used for manufacturing of the tip cap 60 (or an entire syringe 10)—in order to ensure close proximity with the RFID tag 62 without any contact with the carrier tool 74. Thus, as a non-limiting example, the end portions 112 of dipole coupling element 96 may be spaced apart by a distance of 10 mm, although it is recognized that the exact spacing will be dependent on the design/configuration of the RFID tag 62 and/or the carrier tool 74 used for assembly/manufacturing of the tip cap 60. In addition to spacing apart of the end portions 112 to correlate with the construction of the carrier tool 74, the extension of the end portions 112 out from front surface 98 also enables reading of the RFID tag 62 assembled into the tip cap 60 with the carrier tool 74 made from steel or stainless steel.

According to another aspect of the disclosure, the polarization axis or dipole axis of the dipole coupling element 96 is angularly aligned with a polarization axis or dipole axis of the RFID tag 62. In some embodiments, the polarization axis or dipole axis of the dipole coupling element 96 is aligned so as to be in parallel with the polarization axis or dipole axis of the RFID tag 62. In other embodiments, the polarization axis or dipole axis of the dipole coupling element 96 is aligned so as to be considered “substantially parallel” with the polarization axis or dipole axis of the RFID tag 62—with the polarization axis or dipole axis of the dipole coupling element 96 being within +/−30 degrees of parallel to the polarization axis or dipole axis of the RFID tag 62.

With the end portions 112 of dipole coupling element 96 aligned with the RFID tag 62 as described above, the dipole coupling element 96 may effectively focus an electromagnetic field toward the RFID tag 62 of a RFID-tagged syringe 10 that passes thereby (i.e., through reading location 108). With the RFID coupling element 80 employing a near-field electromagnetic dipole coupling element 96 that is able to better focus an electromagnetic field on an individual RFID-tagged syringe 10 (and RFID tag 62 therein), each individually RFID-tagged syringe 10 can be dynamically read by the RFID reading system 76 without a cross-reading defect potentially occurring—with a cross-reading defect referring to when the RFID-tagged syringes 10 are not read in the correct conveying run order (i.e., a 2^{nd} position syringe is read before a 1^{st} position syringe).

According to aspects of the disclosure, the end portions 112 of the dipole coupling element 96 have a length that enables a singulated reading of each respective RFID-tagged syringe 10 as it passes by the RFID coupling element 80—i.e., at the “reading location 108” where the RFID-tagged syringe 10 passes in proximity to and in front of the RFID coupling element 80. That is, with the RFID-tagged syringe 10 passing the RFID coupling element 80 at a high conveying speed (e.g., approximately 1 m/s), and with the RFID-tagged syringes 10 on conveyor system 72 having a tight pitch (e.g., approximately 19 mm), the dipole coupling element 96 must be configured so as to enable a sufficient reading of the RFID tag 62 of the syringe 10, while such readings should not be subject to a cross-reading defect. According to embodiments, the end portions 112 of dipole coupling element 96 may have a length of between 1 mm and 100 mm, and preferably between 10 mm and 20 mm-with such a length of the end portions 112 being determined to enable a reading of the RFID-tagged syringe 10 as it passes along a conveyor path and through the reading location 108. That is, the RFID-tagged syringe 10 should be “close enough for long enough” to the dipole coupling element 96 of the RFID coupling element 80 to enable reading of the RFID-tagged syringe 10, with the afore-mentioned length of the end portions 112 of dipole coupling element 96 (in parallel to the path of travel of the RFID-tagged syringe 10, in the x-dimension, as it passes the dipole coupling element 96) being long enough to provide for such reading without being too long so as to cause potential a cross-reading defect. In some embodiments, for the “close enough for long enough” reading of the RFID-tagged syringe 10, the following parameters should be met: (1) the positioning of the RFID tag 62 of each RFID-tagged syringe 10 relative to the dipole coupling element 96 as it passes through the reading location 108 is such that the separation between the RFID coupling element 80 and the RFID-tagged syringes 10 in the z-dimension should be controlled so as to be between 1 mm and 50 mm, and (2) the RFID tag 62 of each RFID-tagged syringe 10 should pass through the reading location 108 (i.e., aligned with the dipole coupling element 96 in the x-dimension) for a reading period of approximately 6 ms, with it recognized that the width of the end portions 112 and the speed of the conveyor system 72 affect the reading period.

In furtherance to the description of the conveyor system 72 and RFID reading system 76 set forth above, following now is a description of a method of operation of the conveyor system 72 and RFID reading system 76 by which a retrieving of a UID from each of a plurality of RFID-tagged medical devices may be performed.

The method begins by manufacturing or otherwise providing a plurality of RFID-tagged medical devices 10 that each incorporate therein an RFID tag 62. The RFID tag 62 may include thereon information identifying the medical device (e.g., syringe size/volume, medicament information, manufacture date, etc.) and provides for tracking/traceability of the RFID-tagged medical device 10 from the manufacturing process until the final labeling, the final use, or the disposal thereof. As previously described, the RFID-tagged medical devices 10 may be any of a number of different medical devices, including medical injection devices such as (prefilled) syringes or auto-injectors, or safety devices, as non-limiting examples. In still other embodiments, the RFID-tagged medical devices 10 may be a particular component of such medical injection devices or safety devices that are not yet fully assembled with other components.

The RFID-tagged medical devices 10 include an RFID tag 62 incorporated therein, such as being inlaid within the medical device or applied onto an outer surface of the medical device. For example, where the RFID-tagged medical devices 10 comprise RFID-tagged syringes (hereafter “RFID-tagged syringes 10”), the RFID tag 62 may be integrated into the tip cap 60 of the syringe or may be applied onto another component of the syringe 10, such as onto the syringe barrel 12 (i.e., onto the cylindrical outer wall 16 or flange 26 thereof) or onto the plunger rod 36. In each of these embodiments, the RFID tag 62 conforms to the surface(s) or wall(s) to or within which it is disposed, such that when the RFID tag 62 is integrated with/on a cylindrical component such as the tip cap 60 or barrel 12, the RFID tag 62 will have a curvature that matches that of the tip cap 60 or barrel 12. It is recognized that this curvature of the RFID tag 62 in/on the RFID-tagged syringe 10 may make reading of the RFID tag 62 (as part of a quality control analysis) more challenging.

The RFID-tagged syringes 10 may be conveyed along a conveyor system 72 as part of the manufacturing process. In the case of pre-filled syringes, for example, filling of the RFID-tagged syringes 10 with a medicament and/or stoppering of the RFID-tagged syringes 10 may occur as the RFID-tagged syringes 10 are conveyed by the conveyor system 72—with the conveyor system 72 translating the RFID-tagged syringes 10 along a pre-defined conveyor path and at a pre-defined conveyor speed, and with the RFID-tagged syringes 10 arranged with a specified pitch, as determined by manufacturing requirements and specifications.

To enable retrieving a UID for each of the RFID-tagged syringes 10, the RFID-tagged syringes 10 are advanced along the conveyor system 72 to a location where they are read by the RFID reading system 76. In particular, the RFID reading system 76 may perform a singulated reading of the RFID tag 62 in each RFID-tagged syringe 10 in order to determine whether the RFID tag 62 is operable and/or otherwise meets specified quality control parameters. As indicated previously, the conveyor system 72 may be operated as a high throughput conveyer line that conveys the RFID-tagged syringes 10 along the conveyor path at a speed and a pitch that provides for singulated readings of the RFID-tagged syringes 10 at up to 6,000 parts/min, with the RFID coupling element 80 constructed accordingly to enable such singulated readings of the RFID-tagged syringes 10 as they are moved along the conveyor system 72, while also minimizing/eliminating the potential for cross-reading defects during reading of the RFID-tagged syringes 10.

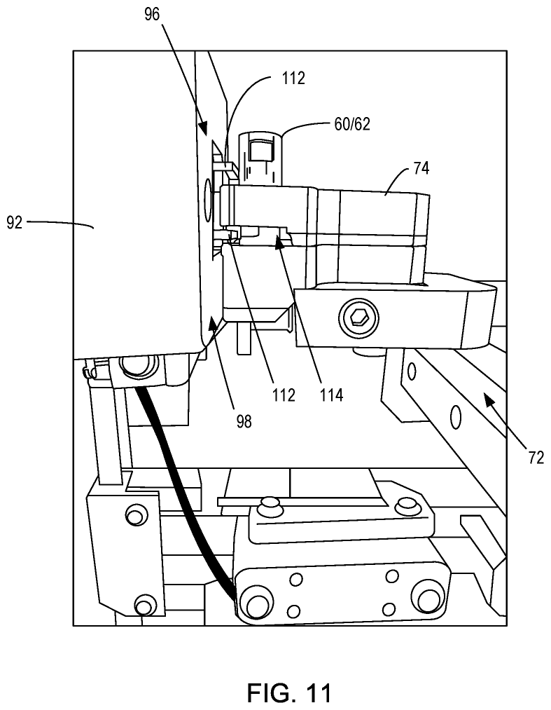

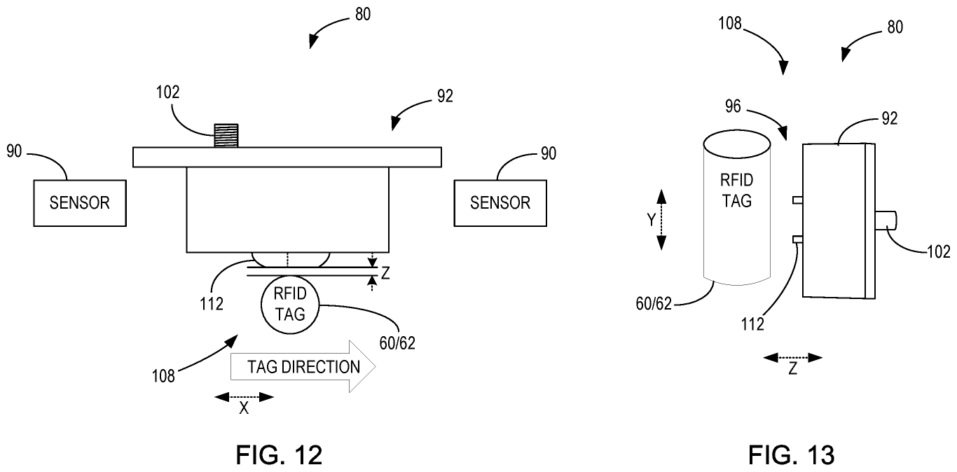

In order to provide for reading of the RFID-tagged syringes 10 by the RFID reading system 76, the RFID-tagged syringes 10 are advanced along a conveyor path to a reading location 108—where the RFID-tagged syringes 10 pass in front of and in proximity to the RFID coupling element 80 of the RFID reading system 76. As shown in FIGS. 9-11 and now also in FIGS. 12 and 13, the RFID coupling element 80 may be positioned at a location relative to the RFID-tagged syringes 10 (as they pass by the reading location 108) that ensures a proper reading of the RFID tags 62 therein—with the dipole coupling element 96 of RFID coupling element 80 centered vertically (in the y-dimension) relative to the RFID tag 62 of the syringes and separated therefrom by a gap (in the z-dimension) of between 1 mm and 50 mm, as a non-limiting example. As previously described, positioning of the RFID coupling element 80 (and dipole coupling element 96 thereof) at a desired location may be provided by mounting and adjustment mechanisms provided on the RFID coupling element 80 structure, with these mechanisms providing 3-dimensional positional adjustment.

As each RFID-tagged syringe 10 passes through the reading location 108 adjacent the RFID coupling element 80, the RFID reading system 76 is operated to perform a singulated reading of each RFID-tagged syringe 10. The process implemented by the RFID reading system 76 to perform this singulated reading of each RFID tag 62 of each RFID-tagged syringe 10 is explained in further detail now.

According to some aspects of the disclosure, as an initial step of the reading process, a trigger signal is generated by PLC 84 and transmitted to the RFID reader 78. As a non-limiting example, the trigger signal may be provided as a “high” trigger signal that causes the RFID reader 78 to initiate a reading process or a “low” trigger signal responsive to which the RFID reader stops a reading process. The trigger signal may have an amplitude of 5-24 Vdc, dependent on whether it is a high or low signal. According to one embodiment, the high and low trigger signals may be generated by PLC 84 based on signals received by the PLC 84 from one or more sensors 90 that identify positioning of the RFID-tagged syringes 10 on the conveyor system 72 relative to the RFID coupling element 80, with such positional information determining appropriate times for triggering the RFID reader 78 and RFID coupling element 80 to enable a singulated reading of each RFID-tagged syringe 10. That is, when the sensor(s) 90 determine that a RFID-tagged syringe 10 is in front of RFID coupling element 80 (i.e., dipole coupling element 96 thereof) or is about to pass in front of RFID coupling element 80, the trigger signal may be set to high to cause the RFID reader 78 to initiate a reading process, and upon the sensor(s) 90 determining that the RFID-tagged syringe 10 is no longer in front of the RFID coupling element 80, the trigger signal may be set back to low to cause the RFID reader 78 to stop the reading process for that RFID-tagged syringe 10. In performing the reading of RFID tags 62, it is recognized that the trigger position at which a reading of each RFID-tagged syringe 10 begins/ends must therefore be consistent, with a tolerance of +/−1.0 mm in the x-dimension (the direction of travel of the RFID-tagged syringes 10) being acceptable, as a non-limiting example.

While operation of the control system 82 is described above as sensor(s) 90 providing positional information to PLC 84 and PLC 84 then transmitting trigger signals to RFID reader 78, the control system 82 may instead be configured such that sensor(s) 90 are in direct communication with RFID reader 78 (as shown in dashed lines in FIG. 5)—with sensor(s) 90 further configured to send trigger signals directly to the RFID reader 78. In such embodiments, the sensor(s) 90 may generate the high and low trigger signals based on positioning of the RFID-tagged syringes 10 on the conveyor system 72 relative to the RFID coupling element 80 and provide these signals to the RFID reader 78 to control the timing for triggering the RFID reader 78 and RFID coupling element 80 to enable a singulated reading of each RFID-tagged syringe 10.

When the RFID reader 78 initiates a reading procedure (responsive to a trigger signal), the RFID reader 78 sets and outputs a power to the RFID coupling element 80 (i.e., to dipole coupling element 96) to enable reading of a RFID-tagged syringe 10 currently at the reading location 108. In some embodiments, the output power provided from the RFID reader 78 to the RFID coupling element 80 may be based on a separation distance (in the z dimension) between the RFID coupling element 80 and the RFID tag 62 of the RFID-tagged syringe 10, as greater power may be required for a larger separation distance. The output power provided to the RFID coupling element 80 by the RFID reader 78 electromagnetically couples the dipole coupling element 96 of RFID coupling element 80 to the RFID tag 62 of a respective RFID-tagged syringe 10 at the reading location 108. In some embodiments, the electromagnetic field generated by the dipole coupling element 96 of RFID coupling element 80 may be configured as a cone-shaped electromagnetic field of limited size/coverage that is focused toward an individual RFID-tagged syringe 10 that is passing through the reading location 108.

According to aspects of the disclosure, and as best shown in FIG. 12, the reading of the RFID tag 62 of the RFID-tagged syringe 10 (responsive to the high trigger signal) may occur while the RFID tag 62 is in alignment with the dipole coupling element 96, as it passes through the reading location 108. In some embodiments, the RFID tag 62 of each RFID-tagged syringe 10 may be aligned with the dipole coupling element 96 (in the x-dimension) for a reading period of approximately 6 ms, as a non-limiting example, so as to enable a proper reading of the RFID tag 62. It recognized that the width of the end portions 112 (in the x dimension) of dipole coupling element 96 and the speed of the conveyor system 72 affect the reading period, and therefore the reading period may differ.

According to aspects of the disclosure, the electromagnetic coupling of the RFID coupling element 80 to the RFID tag 62 of a respective RFID-tagged syringe 10 at the reading location 108 may generate a response from the RFID tag 62 at 800-1000 MHz (i.e., over a full RFID UHF bandwidth), with +/−10 dB accuracy. The response from the RFID tag 62 may be detected by the RFID reader 78, with the RFID reader 78 retrieving a unique UID from the RFID tag 62. In accordance with some aspects of the disclosure, the RFID reader 78 may optionally be programmed or configured to output the UID to the server/database 86, with the server/database 86 receiving the UID from the RFID reader 78 resulting from the reading of the RFID-tagged syringe 10 and storing the reading/UID in a memory module.

With regard to the reading of each RFID-tagged syringe 10 as described above, it is recognized that a number of RFID-tagged syringes 10 conveyed along conveyor system 72 may fail the quality control check performed by the RFID reading system 76. For example, the RFID tag 62 of a respective RFID-tagged syringe 10 may be inoperable/defective, such that no response is received from that RFID tag 62 (i.e., no UID is retrieved) when the RFID reading system 76 attempts to read the RFID tag. According to aspects of the disclosure, the RFID reader 78 is configured to determine/identify when the RFID tag 62 of each respective RFID-tagged syringe 10 is successfully or unsuccessfully read, with the RFID reader 78 or controller 86 generating an appropriate “Pass” or “Fail” signal responsive thereto.

In the event that the RFID reader 78 is able to successfully read the RFID tag 62 of each respective RFID-tagged syringe 10 and retrieve the UID therefrom, the RFID reader 78 may generate and transmit a Pass signal to the PLC 84. Additionally, the RFID reader 78 may optionally output the UID from the successful reading to the server/database 86 for storage.

In the event that the RFID reader 78 is unable to read the RFID tag 62 (and not retrieve the UID) of each respective RFID-tagged syringe 10, the RFID reader 78 may generate and transmit a Fail signal to the PLC 84. In some embodiments, receipt of a Fail signal by the PLC 84 causes the PLC 84 to generate/output a command that causes the conveyor system 72 to eject the failed RFID-tagged syringe 10 from the conveying path. For example, the holding or gripping device 74 that retains the failed RFID-tagged syringe 10 may receive the command signal and, responsive thereto, may release/eject the failed RFID-tagged syringe 10 from the conveyor system 72.

As indicated, the RFID reading system 76 operates to provide a singulated reading for each of the RFID-tagged syringes 10 conveyed by the conveyor system 72. Accordingly, it is recognized that the method of operation of the RFID reading system 76 described in detail above is repeated for the reading of each RFID-tagged syringe 10. The singulated reading of each of the RFID-tagged syringes 10 may be utilized as part of a quality control check ensuring operability of the RFID tag 62 in each RFID-tagged syringe 10.

Beneficially, embodiments of the invention thus are directed to a system and method for the reading of RFID-tagged medical devices during the manufacturing thereof. The system and method provide an accurate singulated reading of an RFID tag incorporated into such RFID-tagged medical devices, in accordance with the required pitch and conveyance speed associated with the manufacturing environment of the RFID-tagged medical devices, with a high reading throughput (up to 6,000 parts/min) being achievable. A RFID coupling element is provided that enables the singulated reading of the RFID tag in each RFID-tagged medical device as it proceeds along a conveyor system at a high speed and with minimized pitch, with such reading being provided while minimizing potential for a cross-reading defect. The ability to perform a singulated reading of the RFID tag in each RFID-tagged medical device allows for an RFID reading system to retrieve a unique identifier from each RFID-tagged medical device. In some embodiments, singulated reading of the RFID tag in each RFID-tagged medical device may be performed as a quality control check of the RFID-tagged medical devices during manufacturing, with defective RFID-tagged medical devices being identified and removed from the conveyor system. Accordingly, more strict quality controls may be implemented during high throughput manufacturing/assembly of RFID-tagged medical devices.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment may be combined with one or more features of any other embodiment.

The invention claimed is:

1. A radio frequency identification (RFID) reading system for performing a singulated reading of each of a plurality of RFID-tagged medical devices being conveyed by a conveyor system along a conveying path, the RFID reading system comprising:
a RFID coupling element positioned at a reading location along the conveying path, the RFID coupling element comprising:
a housing comprising a front surface, a back surface, and a plurality of mounting features;
a dipole coupling element positioned at least partially within the housing, the dipole coupling element including a pair of chamfered end portions; and
a housing mount to which the housing is secured, with at least some of the plurality of mounting features aligned with the housing mount to enable securing of the housing to the housing mount; and
a RFID reader operably connected with the RFID coupling element, the RFID reader configured to provide power to the RFID coupling element to electromagnetically couple the dipole coupling element to an RFID tag incorporated in a respective RFID-tagged medical device as it passes in front of and in proximity to the dipole coupling element, at the reading location;
wherein, upon the electromagnetic coupling of the dipole coupling element to the respective RFID-tagged medical device, the RFID reader performs a singulated reading of the RFID tag in the RFID-tagged medical device.

2. The RFID reading system of claim 1, wherein the end portions of the dipole coupling element have a width, in an x-dimension, sufficient to acquire a reading of the RFID-tagged medical device as it passes the reading location.

3. The RFID reading system of claim 1, wherein the end portions of the dipole coupling element are separated in a y-dimension.

4. The RFID reading system of claim 3, wherein the end portions of the dipole coupling element are separated in the y-dimension by a distance determined by a configuration of the RFID tags of the RFID-tagged medical devices.

5. The RFID reading system of claim 3, wherein the end portions of the dipole coupling element are separated in the y-dimension by a distance determined by a configuration of carrier tools of the conveyor system that hold the RFID-tagged medical devices.

6. The RFID reading system of claim 1, wherein a polarization axis or dipole axis of the dipole coupling element is substantially parallel to a polarization axis or dipole axis of the RFID tag included in each respective RFID-tagged medical device.

7. The RFID reading system of claim 6, wherein the polarization axis or dipole axis of the dipole coupling element is within +/−30 degrees of parallel to the polarization axis or dipole axis of the RFID tag.

8. The RFID reading system of claim 1, wherein the plurality of mounting features and the housing mount enable 3-dimensional positional adjustment of the housing and the dipole coupling element, the positional adjustments including:
a positional adjustment in an x-dimension parallel to a direction of travel of the conveying path at the reading location;
a positional adjustment in a z-dimension, away from and towards a respective RFID-tagged medical device when at the reading location; and
a positional adjustment in a y-dimension, vertically up and down relative to a respective RFID-tagged medical device when at the reading location, so as to enable vertical centering of the dipole coupling element relative to a RFID tag in a respective RFID-tagged medical device.

9. The RFID reading system of claim 8, wherein positional adjustments of the housing and the dipole coupling element in the z-dimension enable adjustment of up to 50 mm, in increments of 0.1 mm or less.

10. The RFID reading system of claim 8, wherein positional adjustments of the housing and the dipole coupling element in the y-dimension enable adjustment of up to 2 mm, in increments of 0.1 mm or less.

11. The RFID reading system of claim 1, wherein the housing is formed of one or more cleanroom-compatible materials.

12. The RFID reading system of claim 1, wherein at least a portion of the front surface of the housing adjacent or in close proximity to the end portions of the dipole coupling element is formed of non-metallic material compatible with radio-frequency constraint and performance.

13. The RFID reading system of claim 1, further comprising a radio frequency (RF) cable connecting the RFID reader to the RFID coupling element, the RF cable enabling positioning of the RFID coupling element at the reading location, along the conveying path.

14. The RFID reading system of claim 1, wherein the plurality of RFID-tagged medical devices comprise assembled RFID-tagged syringes, RFID-tagged syringe tip caps, RFID-tagged auto-injectors, or RFID-tagged safety devices.

15. A radio frequency identification (RFID) coupling element for use with a RFID reader for performing a singulated reading of each of a plurality of RFID-tagged medical devices being conveyed by a conveyor system along a conveying path, the RFID coupling element comprising:
a housing comprising a front surface and a back surface and a plurality of mounting features;
a housing mount to which the housing is secured, with at least some of the plurality of mounting features aligned with the housing mount to enable securing of the housing to the housing mount; and
a dipole coupling element positioned at least partially within the housing, the dipole coupling element having a pair of chamfered end portions;
wherein, upon power being provided to the dipole coupling element, the dipole coupling element is electromagnetically coupled to a RFID tag incorporated in a respective RFID-tagged medical device as it is conveyed along the conveying path to a reading location, where it passes in front of and in proximity to the dipole coupling element, so as to enable a singulated reading of the RFID-tagged medical device.

16. The RFID coupling element of claim 15, wherein the end portions of the dipole coupling element have a width, in an x-dimension, sufficient to acquire a reading of the RFID-tagged medical device as it passes the reading location.

17. The RFID coupling element of claim 15, wherein the end portions of the dipole coupling element are separated in a y-dimension by a distance determined by a configuration of the RFID tags of the RFID-tagged medical devices and/or by a configuration of carrier tools of the conveyor system that hold the RFID-tagged medical devices.
